(19) United States
(12) Patent Application Publication
(10) Pub. No.: US 2001/0025324 A1
(43) Pub. Date: Sep. 27, 2001

(54) Data communication method and apparatus, and storage medium storing program for implementing the method and apparatus

(76) Inventor: Tsutomu Gamo, Kanagawa (JP)

Correspondence Address: Jay H. Maioli, Cooper & Dunham LLP, 1185 Avenue of the Americas, New York, NY, 10036, US

(21) Appl. No.: 09/784,924

(22) Filed: Feb. 16, 2001

(30) Foreign Application Priority Data
Feb. 21, 2000 (JP) P2000-043390

(51) Int. Cl. G06F 9/44; G06F 9/46

(52) U.S. Cl. 709/315; 709/313

(57) ABSTRACT

In a data communication method and apparatus, message communication within a complex object is executed in the same execution thread, and a history of message communication is updated to indicate message communication from the same execution thread. In message communication directed from within a complex object to an external object, a message or messages are temporarily stored on a destination-by-destination basis. When message processing completes, the history of message communication is checked, so that the stored message or messages are transmitted in a single message communication operation.

### BACKGROUND OF THE INVENTION

1. Field of the Invention

The present invention generally relates to data communication among a plurality of objects in software programs. More specifically, the present invention relates to data communication among a plurality of concurrent objects constituting object-oriented software programs. The present invention is particularly directed to high-speed data communication among such objects, in which cost of message communication relating particularly to context switch is reduced to minimal.

2. Description of the Related Art

With the recent advancement in the LSI (Large Scale Integration) technology, it has become common that information processing apparatuses, communication apparatuses, and household electric apparatuses are electronically controlled by microprocessors executing software programs.

Conventionally, various software programs including control codes have typically been permanently written in ROM (Read Only Memory) incorporated in the apparatuses before shipment. Recently, however, it has become more feasible to incorporate storage devices with writing capability, allowing installation of the latest software via various storage media after shipment. In addition, many of the apparatuses are connected to communication lines such as LAN, the Internet, and the public network, allowing remote access to the latest software without depending on physical distribution of storage media.

Software for controlling an apparatus is usually provided in the form of an operating system (OS). Although not strictly defined, an operating system is basically responsible for serving as an intermediary between the hardware and the upper-layer application programs, i.e., providing an API (Application Programming Interface) for the application programs, and for an overall control of the hardware. A combination of hardware and operating system is generally called a “platform”. The operating system provides execution environments for application programs and device drivers. With the operating system as an intermediary, a single application program can be executed on different types of machines.

In the field of software development, there is a trend in favor of what is called “object-oriented” technology which places emphasis on data to be processed rather than procedure of processing. It is generally believed that object-oriented technology serves to enhance efficiency in software development and maintenance. Object-oriented software basically consists of modules called “objects” in which data and processing procedure therefor are integrated. A piece of object-oriented software is implemented by creating and combining a plurality of objects as required.

The implementation of object-oriented paradigm involves four basic concepts; namely, “encapsulation”, “class/instance”, “class inheritance”, and “message passing”.

Encapsulation refers to integration of data and procedure (method). Class refers to a group of objects which are commonly defined. Instance refers to objects as entities belonging to a class. Instances belonging to the same class usually have the same method; thus the method need not be defined for each of the instances individually. Inheritance indicates that the definition of a class is inherited by another (for example, lower) class. Thus, a new class can be defined by adding to or altering the definition of a previously defined class. Message passing refers to sending messages to objects which execute particular operations. Each of the objects hides its own data, inhibiting access thereto in any method other than message passing.

Recently, object-oriented technology is being adopted for operating systems. More specifically, individual components of the operating systems are being modularized as concurrent objects which are responsible for execution. An operating system of the type is hereinafter referred to as an “object-oriented operating system”, and a concurrent object is simply referred to as an “object”. If objects constituting an operating system and objects constituting an application program to be executed on the operating system have similar execution functions, the object-oriented operating system is sometimes called a “pure object-oriented operating system”.

In an object-oriented operating system, each of the services provided by the operating system is defined in terms of a group of objects. This feature renders the object-oriented operating system advantageous than the conventional operating system in terms of flexibility in system configuration and ease in dynamic reconfiguration of the system.

More specifically, an operating system which provides functionality required by a particular user can be readily configured by combining a plurality of objects for executing the required tasks before implementation of the operating system. Furthermore, functionality may be dynamically added or removed to upgrade or optimize the system without suspending the operation of the system.

In an object-oriented operating system, the objects providing services of the system run concurrently with one another. The objects are each modularized, and use a message communication mechanism to communicate with one another, for example, to exchange messages and to achieve synchronization.

Message communication among objects incur cost for saving and restoring states of execution threads of the objects, and cost for delivering messages. Thus, in an object-oriented operating system, if message communication frequently occurs among objects, context switching occurs just as often, degrading overall performance of the system.

Accordingly, designers of object-oriented operating systems need to not only incorporate the advantages of object-oriented operating systems such as flexibility in system configuration and ease in dynamic reconfiguration of the system, but also sufficiently take into account the balance between the advantages and actual performance of the system.

Japanese Patent Application No. 11-57689, already assigned to the assignee of the present invention, discloses a data processing method in which cost relating to message communication among objects is reduced to enhance overall performance of the system. According to the data processing method, a group of objects which causes frequent message communication is integrated into and defined as a “complex object”.

Each of the objects constituting the complex object is programmed in the same style as ordinary concurrent objects external to the complex object (i.e., requires no change), and includes an object identifier (OID) so as to allow reference from the ordinary objects. The objects within the complex object are not provided with execution environments of their own, and instead share an execution environment of the complex object. When message communication occurs among objects within the complex object, switching of execution environment, i.e., context switch, does not occur. Thus, cost relating to message communication is equivalent to that of a function call.

The data processing method is very effective in that by constituting a complex object on an object-oriented operating system, cost relating to message communication is reduced while maintaining flexibility of the system.

In constituting a complex object which includes two or more objects, there are restrictions for each of the objects to be included in the complex object. Although the restrictions somewhat varies depending on the functions provided by the operating system, the restrictions can be summarized as follows:

(1) The objects have execution seriality. More specifically, execution seriality is recognized when the following two conditions are satisfied.

(1-1) When sending a message from a first object to a second object, the first object and the second object are not required to run concurrently.

(1-2) When sending a message from a first object to a second object, the second object is never under processing another message.

(2) When sending a message from a first object to a second object, the scheduling priority level of the execution thread of the second object is equivalent to or higher than that of the first object.

(3) When sending a message from a first object to a second object, the interrupt: priority level of the execution thread of the second object is equivalent to or higher than that of the first object.

(4) The objects have the same memory protection properties.

That is, it is not allowed to include objects which do not satisfy the above conditions into a single complex object. Although Japanese Patent Application No. 11-57689 describes in detail a method of constituting a complex object, the method involves restrictions as described regarding the type of objects which can be included in the complex object.

Thus, even if there is a set of objects which causes frequent message communication among them, the set of objects is not allowed to be integrated into a complex object and thus must be independent of one another as ordinary concurrent objects unless the set of objects satisfies the above conditions. Consequently, context switch occurs each time the frequent message communication occurs, inhibiting reduction, of cost relating to message communication.

By way of example, a scheduler which controls scheduling of tasks is not allowed to be included in a complex object. Thus, even in message communication within the complex object, context switch occurs every time each of the component objects calls the scheduler, increasing cost of message communication. Scheduler calls are very frequent in data processing.

### SUMMARY OF THE INVENTION

Accordingly, it is an object of the present invention to provide a data communication method and apparatus which are advantageous in message communication among a plurality of objects.

It is another object of the present invention to provide a data communication method and apparatus suitable for exchanging messages among objects in an object-oriented operating system constituted of a plurality of concurrent objects.

It is yet another object of the present invention to provide a data communication method and apparatus in which cost of message communication particularly due to context switch is reduced to minimal so as to achieve higher speed of message exchange among objects.

It is still another object of the present invention to provide a data communication method and apparatus in which cost of message communication among objects is reduced to minimal while maintaining the advantages of object-oriented operating systems such as flexibility in system configuration and ease in dynamic reconfiguration of the system so as to enhance overall performance of the system.

It is a further object of the present invention to provide a data communication method and apparatus in which even when each of the objects constituting a complex object causes frequent message communication with a particular external object, cost relating to context switch is reduced while maintaining independence of each of the objects so as to enhance overall performance of the system.

It is a yet further object of the present invention to provide a storage medium storing a program for implementing any of the methods and the apparatuses as above.

In view of the above, according to one aspect of the present invention, there are provided a data communication method and apparatus for exchanging messages, under a system environment constituted of a plurality of objects which executes message communication, between a complex object constituted of a plurality of objects having execution seriality and an independent object external to said complex object. The data communication method and apparatus include the steps of and device for:

(a) temporarily storing one or more messages directed from an object within the complex object to the independent object external to the complex object; and

(b) sending the one or more stored messages to the independent object in a single operation when the complex object and the independent object enter a predetermined relationship.

The data communication method and apparatus is implemented in, for example, a data processing system incorporating an object-oriented operating system constituted of a plurality of concurrent objects executing message communication.

According to the data communication method and apparatus, first, a plurality of objects which causes frequent message communication is integrated into a complex object. The objects have execution seriality so that when an object within the same complex object is invoked, message communication is executed in the same thread. Thus, context switch does not occur and therefore cost relating to message communication is not incurred.

When message communication is invoked from within the complex object to an independent object external to the complex object, context switch occurs. In addition, even in message communication within the complex object, it may be the case that an independent object external to the complex object, such as a scheduler, must be called frequently. Executing message communication operation on each and every call significantly increases cost relating to message communication due to context switch.

Accordingly, in the data communication method and apparatus, when an object within the complex object calls an independent object external to the complex object, message or messages directed to the independent object are temporarily stored in a queue instead of being sequentially transmitted. Then, the message or messages are sent to the independent object in a single operation when the complex object and the independent object enter a predetermined relationship.

Thus, cost of message communication particularly due to context switch is reduced to minimal, achieving higher speed of message exchange among objects.

In addition, cost of message communication among objects is reduced to minimal while maintaining the advantages of object-oriented operating systems such as flexibility in system configuration and ease in dynamic reconfiguration of the system, enhancing overall performance of the system.

Furthermore, even when each of the objects constituting a complex object causes frequent message communication with a particular external object, cost relating to context switch is reduced while maintaining independence of each of the objects, enhancing overall performance of the system.

Preferably, the data communication method and apparatus include the step of and device for:

(c) creating a history of message communication by the object within the complex object.

In the data communication method and apparatus, the step and device (b) may determine whether the complex object and the independent object has entered said predetermined relationship based on the history of message communication. The method and device (b) may also send the one or more stored messages in a single operation if the history of message communication is indicative of a message communication from a different execution thread when the object within the complex object exits execution.

The method and device (a) may control message storing in accordance with a relationship between the complex object and the independent object.

Alternatively, the method and device (a) may control message storing in accordance with the status of the independent object.

For example, if communication occurs within the complex object, i.e., a message or messages are directed from an object within the complex object to another object within the same complex object, message communication is executed in the same execution thread. At this time the history of message communication is updated to indicate message communication from the same execution thread.

A message or messages are directed from an object within the complex object to an ordinary object external to the complex object, the message or messages are temporarily stored on a destination-by-destination basis instead of being immediately transmitted. If the history of message communication indicates communication from the same execution thread, a return processing is executed. If the history of message communication indicates communication from a different execution thread, the stored message or messages are sent to receiver object or objects in a single message communication operation. Then, the complex object exits execution.

It is preferable that the step and device (a) control message storing on a destination-by-destination basis if the one or more stored messages are directed from the object within the complex object to a plurality of independent objects external to the complex object.

More preferably, the data communication method and apparatus include the step of and device for:

(d) determining whether to store or immediately send the one or more messages in accordance with a relationship between the complex object which sends the one or more messages and the independent object which receives the one or more messages, with respect to scheduling priority level and interrupt priority level of the respective execution threads thereof.

In accordance with the data communication method and apparatus, when message communication occurs frequently between objects within the complex object and objects external to the complex object, messages are stored transparently from the perspective of the objects within the complex object, and are then transmitted in a single message communication operation at an appropriate timing. Thus, cost of message communication is significantly reduced. In addition, the overall performance of the system can be enhanced while maintaining independence of each of the objects.

The data communication method and apparatus may be implemented in application programs and device drivers constituted of a plurality of concurrent objects as well as to object-oriented operating systems.

According to another aspect of the present invention, there is provided a computer-readable storage medium storing a computer program for exchanging messages, under a system environment constituted of a plurality of objects which executes message communication, between a complex object constituted of a plurality of objects having an execution seriality and an independent object external to said complex object. The computer program includes the steps of:

(a) temporarily storing one or more messages directed from an object within the complex object to the independent object external to the complex object; and

(b) sending the one or more stored messages to the independent object in a single operation when the complex object and the independent object enter a predetermined relationship.

The computer-readable storage medium provides an executable computer program for a general computer system capable of executing various program codes. The storage medium is of the type which is detachable and portable, including, for example, CD (Compact Disc), FD (Floppy Disk), and MO (Magneto-Optical Disk). It is also technically feasible to provide a computer program to a particular computer system via transmission media such as wired and wireless networks.

The storage medium storing the computer program defines how a computer program and a computer system are structurally and functionally associated in order to implement the computer program on the computer system. That is, the storage medium is used to install the computer program on the computer system so that the computer system will operate in association with the computer program, which is equally advantageous as the first aspect of the present invention.

The above and other objects, features, and advantages of the present invention will become more apparent from the following detailed description of the preferred embodiment when taken in conjunction with the accompanying drawings.

### BRIEF DESCRIPTION OF THE DRAWINGS

FIG. 1 is a schematic representation of the hardware configuration of a data processing system in an embodiment of the present invention;

FIG. 2 is a schematic representation of the software environment of the data processing system;

FIG. 3 is a schematic representation of a message communication operation between different execution environments provided by an object-oriented operating system, and more specifically, it illustrates a message communication operation between an application program which runs on an execution environment mCOOP and a device driver which runs on an execution environment mDrive;

FIG. 4 is a schematic representation of a message communication operation between the application program which runs on the execution environment mCOOP and the device driver which runs on the execution environment mDrive, and more specifically, it illustrates an operation within the operating system during the message communication;

FIG. 5 is a flowchart of a method which a meta object mCOOPMailer executes on receiving a “SendWithRBox” message from a base object;

FIG. 6 is a flow chart of a method which the meta object mCOOPMailer or a meta object mDriveMailer executes on receiving a “Deliver” message from a base object;

FIG. 7 is a flow chart of a method of an API message “Send” for UnifiedMailermCore;

FIG. 8 is a flow chart of an API message “Exit” for UnifiedMailermCore;

FIG. 9 is a flow chart of API messages “ResumeBase” and ExitFromMetaCall for UnifiedMailermCore; and

FIG. 10 chart showing a processing procedure for the objects when message communication occurs between the application program which runs on the execution environment mCOOP and the device driver which runs on the execution environment mDrive using an API message “SendWithRBox” provided for mCOOP.

### DESCRIPTION OF THE PREFERRED EMBODIMENT

A preferred embodiment of the present invention will be described below with reference to the accompanying drawings.

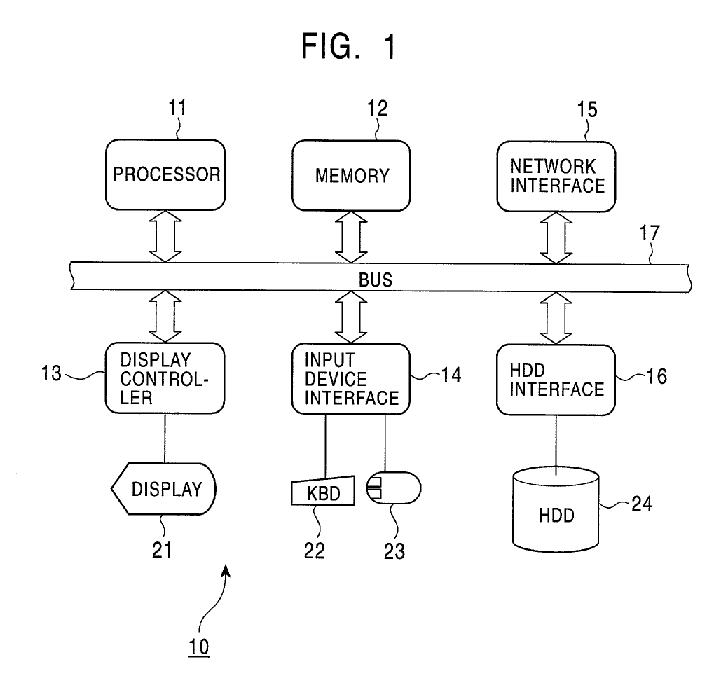

FIG. 1 shows the schematic hardware configuration of a data processing system 10 which serves to implement the preferred embodiment of the present invention. The data processing system 10 is implemented by, for example, an IBM PC/AT (Personal Computer/Advanced Technology) compatible machine or a successor thereof, and may be other types of information processing apparatuses and information household apparatuses. The components of the information processing system 10 will be further described below.

The data processing system 10 includes a processor 11 as a main controller, which is typically a CPU (Central Processing Unit) implemented in the form of an LSI (Large Scale Integration) chip. The processor 11 executes various application programs under the control of an operating system.

As shown in FIG. 1, the processor 11 is connected to other devices via a bus 17. The devices on the bus 17 are assigned with unique memory addresses or I/O addresses which enable the processor 11 to access the devices. The bus 17 may be, for example, a PCI (Peripheral Component Interconnect) bus.

The data processing system 10 further includes a memory 12 which is a storage device for storing program codes to be executed by the processor 11 and for temporarily holding data during execution. It is to be understood that the memory 12 includes both volatile type and non-volatile type memories.

The data processing system 10 further includes a display controller 13 which is dedicated for processing drawing instructions issued by the processor 11, and are compatible with, for example, SVGA (Super Video Graphic Array) or XGA (extended Graphic Array). Graphic data processed by the display controller 13 is temporarily stored in, for example, a frame buffer (not shown), and is then output to a display 21. The display 21 may be, for example, a CRT (Cathode Ray Tube) display or an LCD (Liquid Crystal Display).

The data processing system 10 further includes an input device interface 14 which is a device for connecting user-input devices such as a keyboard 22 and a mouse 23 to the other components of the data processing system 10. The input device interface 14 generates interrupts to the processor 11 in response to key inputs via the keyboard 22 and coordinate indication inputs via the mouse 23.

The data processing system 10 further includes a network interface 15 for connecting the data processing system 10 to a LAN (Local Area Network) or other types of network, in accordance with a particular communication protocol, for example, Ethernet. The network interface 15 is typically implemented by a LAN adapter card which is plugged into a PCI bus slot on a motherboard (not shown).

Typically, there exists on the LAN a plurality of hosts (computers) transparently interconnected with one another to provide a distributed computing environment. One of the hosts serves as a router to connect the LAN to external networks such as other LANs and the Internet. As is known, software programs, data contents, etc. are available for distribution over the Internet.

The data processing system 10 further includes an HDD (Hard Disk Drive) interface 16 for connecting a hard disk drive 24 to the other components of the data processing system 10. The HDD interface 16 conforms to an interface standard, for example, IDE (Integrated Device Electronics) or SCSI (Small Computer System Interface). It is to be understood that other types of external storage device and corresponding interfaces may be used instead of the HDD interface 16 and the hard disk drive 24.

As is known, the HDD 24 is an external storage device in which a magnetic disk is fixedly mounted as a storage medium. The HDD 24 is superior to other external storage devices particularly in terms of storage capacity and data transfer rate. Software programs are executably stored, i.e., installed, on the HDD 24. The HDD 24 typically stores, in a non-volatile fashion, program codes of an operating system, application programs, and device drivers, etc., which are to be executed by the processor 11.

The operating system used in this embodiment is an “object-oriented operating system”, in which individual components are modularized into concurrent objects responsible for execution. Object-oriented software basically consists of modules called “objects” integrating data and processing method for the data. Object-oriented programming creates and combines a plurality of objects as required to implement a piece of software.

The embodiment also involves objects for application programs and device drivers. In this embodiment, an execution environment for the application programs, hereinafter referred to as mCOOP, and an execution environment for the device drivers, hereinafter referred to as mDrive, are provided by the operating system. For example, an application program for displaying motion picture on the display 21, and a program which provides a graphical user interface (GUI) for interactive user inputs via the screen, are executed on mCOOP. Each of the device drivers which directly operates hardware, including the display controller 13, the keyboard 22, the mouse 23, and the HDD interface 16, are executed on mDrive.

In the data processing system 10 as described above, the application programs which run on mCOOP and the device drivers which run on mDrive are allowed to communicate messages between programs in different execution environments as well as between programs in the same execution environment. For example, the GUI program, which runs on mCOOP, implements drawing on the screen by communicating messages with the device driver for controlling the display controller 13, which runs on a different execution environment mDrive.

Next, execution environments provided by the operating system in this embodiment will be described.

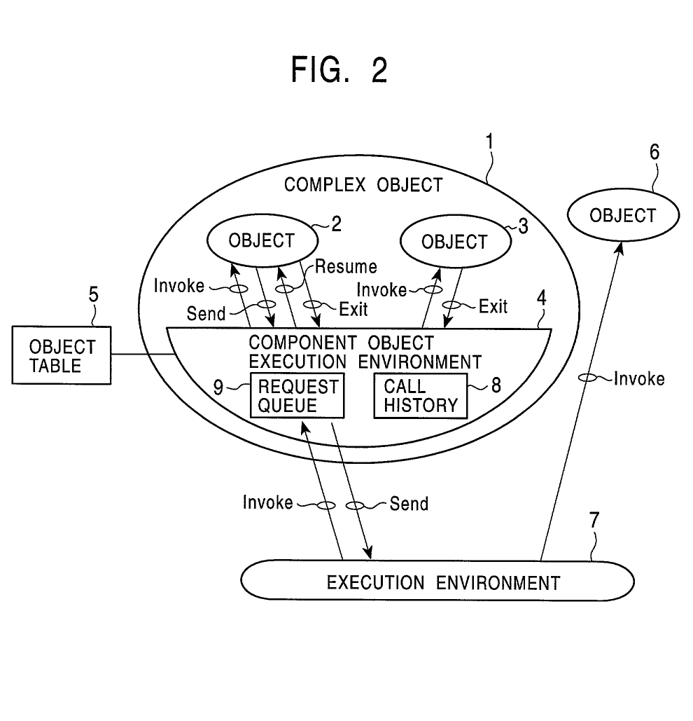

FIG. 2 schematically shows a software environment of the data processing system 10. Referring to FIG. 2, an object 2, an object 3, and an object 6 are objects constituting the operating system. The object 2 and the object 3 are wrapped up to constitute a complex object 1. The object 2 and the object 3 are hereinafter referred to as “component objects” of the complex object 1.

An execution environment 7 provides operating environments for each of the objects constituting the operating system, including the complex object 1 and the object 6. Within the complex object 1, there is provided a special execution environment which supports operations of the component objects 2 and 3, hereinafter referred to as “component object execution environment” 4. Furthermore, in this embodiment, there are provided within the complex object 1 call history 8 which holds information relating to history of message communication of each of the component objects, and a request queue 9 which stores messages sent from the component objects to objects external to the complex object 1. Furthermore, in the execution environment 7, there is provided an object table 5 which holds object description information which are referenced in association with object identifiers (OID).

When an execution request is issued which is directed from an object external to the complex object 1 to one of the components objects 2 and 3 within the complex object 1, the execution request is sent to the component object execution environment 4.

In response to the execution request, the component object execution environment 4 updates the call history 8 to a state indicating message communication from a different thread, and then executes the relevant component object.

When a message transmission request is issued which is directed from one of the component objects 2 and 3 within the complex object 1 to another object, the message transmission request is sent to the component object execution environment 4 within the complex object 1.

In response to the message transmission request, the component object execution environment 4 first searches in the object table 5 for the object designated as the receiver of the message, thereby determining whether the receiver object exists within the complex object 1.

If the receiver object is found to exist within the complex object 1, the component object execution environment 4 updates the call history 8 to a state indicating message communication from within the same thread, and executes the relevant component object in the same thread.

If the receiver object is found to be an object external to the complex object 1, the component object execution environment 4 updates the call history 8 to a state indicating message communication from a different thread, and temporarily stores the message in the request queue 9 with an object identifier identifying the object designated to receive the message.

When ready to exit execution, the complex object 1 sends an exit-execution request to the component object execution environment 4. The component object execution environment 4 then checks the state of the call history 8. If the call history 8 indicates message communication from within the same thread, the component object execution environment 4 resumes, in the same thread, execution of the component object which sent the message. At this time, the call history 8 is restored to the previous state. On the other hand, if the call history 8 indicates message communication from a different thread, the component object execution environment 4 sends, in a single message communication operation, the messages stored in the request queue 9 to the destinations of the messages, and then completes execution as ordinary objects.

It will be understood that in accordance with the object-oriented operating system as described above, cost relating to message communication between the component objects 2 and 3 within the complex object 1 is reduced, and furthermore, cost is reduced transparently from the perspective of the component objects 2 and 3 for message communication between one of the component objects 2 and 3 within the complex object 1 and an ordinary object external to the complex object 1, even if such message communication frequently occurs.

It is to be appreciated that the software configuration as shown in FIG. 2 is applicable to application programs and to device drivers as well as to operating systems.

Next, message communication service between different execution environments provided by the object-oriented operating system in this embodiment will be described.

The object-oriented operating system in this embodiment provides different execution environments as described above, namely, the execution environment mCOOP for application programs and the execution environment mDrive for device drivers.

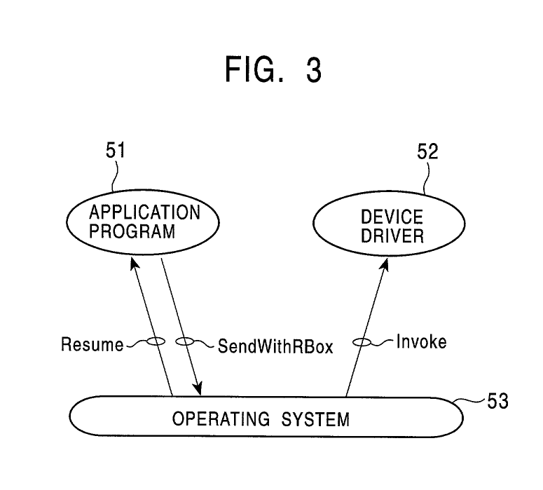

FIG. 3 schematically shows a message communication operation between an application program 51 which operates on the execution environment mCOOP and a device driver 52 which operates on the execution environment mDrive.

The application program 51 is a group of objects which runs on the execution environment mCOOP, and is allowed to use an API (Application Programming Interface) provided by an operating system 53. In requesting transmission of a message, the application program 51 uses a “SendWithRBox” message of the API provided for mCOOP. In passing the “SendWithRBox” message, an object identifier OID identifying a receiver object is attached thereto as an argument thereof. Let it be supposed that the receiver object is the device driver 52 operating on the execution environment mDrive. The operating system 53 identifies the receiver object, i.e., the device driver, by the OID attached to the “SendWithRBox” message, and sends the message to (i.e., invoke) the device driver 52 while simultaneously resuming execution of the application program 51.

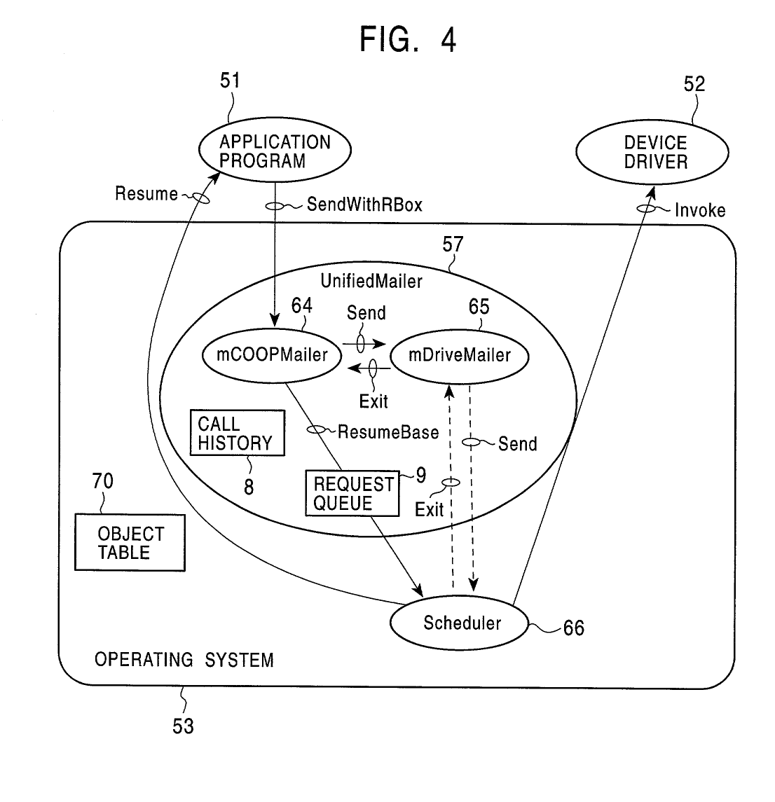

FIG. 4 shows in detail an operation within the operating system 53 when message communication occurs. Relationships between each of the objects will be described hereinbelow with reference to FIG. 4.

Hereinbelow, objects constituting the operating system 53 is referred to as “meta objects”, and objects constituting application programs and device drivers, including the application program 51 and the device driver 52, are referred to as “base objects”.

For the meta objects constituting the operating system 53, there is provided an execution environment for the operating system 53, which differs from the execution environments for the base objects, including mCOOP and mDrive. The execution environment for the operating system 53 is hereinbelow referred to as “mCore”. The mCore as the execution environment for the operating system 53 provides several API messages for the meta objects.

The meta objects are invoked in one of two ways; either in response to a message sent to the meta objects or in response to an API message issued by the base objects. The latter is hereinbelow referred to as a “meta call”. The base objects use API messages for message communication provided by the execution environments of the base objects to issue q meta call. In response to the meta call, there occurs a migration from an execution thread of the base objects to the execution thread of the meta objects. The operation level is switched between the base objects and the meta objects so as to form a boundary between the operating system and the application programs and device drivers, enhancing security of the entire system.

The below describes API messages used in message communication service between different execution environments.

Send:

“Send” message is used to send a message from a sender meta object to a receiver meta object to thereby invoke a method as specified in the argument thereof. When the message is received by the receiver meta object, the sender meta object and the receiver meta object run concurrently. If the receiver meta object is processing another message when the receiver meta object receives a message from the sender meta object, the transmitted message is stored in a message queue and waits until completion of the processing.

Exit:

“Exit” message is used to exit execution of the meta object invoked by a “Send” message. When an “Exit” message is issued, if any messages are stored in the message queue, the messages are invoked.

ResumeBase:

“ResumeBase” message is used to terminate execution of the meta object invoked by a meta-call while resuming execution of the base object which issued the meta-call. “ResumeBase” message is a meta-call from a meta object to the scheduler 66.

ExitFromMetaCall:

“ExitFromMetaCall” message is used to terminate execution of a meta object invoked by a meta-call. Execution of the base object which issued the meta-call is not resumed. “ExitFromMetaCall” message is a meta-call from a meta object to the scheduler 66.

It is to be understood that mCore provides a number of API messages other than described above, but description thereof is omitted herein because those API messages are not directly relevant to the gist of the present invention. It is also to be noted that a method using tags, disclosed in Japanese Patent Application No. 10-283205 already assigned to the assignee of the present invention, may be used to implement message communication services between different execution environments.

mCOOPMailer 64 shown in FIG. 4 is one of the objects constituting the operating system 53, and provides message communication services to the application program execution environment mCOOP. In this embodiment, mCOOPMailer 64 is implemented as a component object of a complex object UnifiedMailer 57.

mCOOPMailer 64 receives messages listed in Table 1 given below and executes corresponding operations.

TABLE 1

| Message | Action |
|---|---|
| SendWithRBox | 1. Create RBox and return RID. |
| | 2. If the receiver object is under the same execution |
| | environment, deliver message to receiver object. |
| | 3. If the receiver object is under a different execution |
| | environment, send “Deliver” message to meta object |
| | which implements message communication under that |
| | execution environment. |
| Receive | 1. Search RBox by RID. |
| | 2. Deliver result message to RBox. |
| Reply | 1. Convert RID into TID. |
| | 2. If TID is for the same execution environment, |
| | deliver result message to RBox corresponding to RID. |
| | 3. If TID is for different execution environment, send |
| | “DeliverTag” message. |
| Exit | 1. Send message in message queue, if any. |
| | 2. Otherwise, exit execution. |
| Deliver | Deliver message. |
| DeliverTag | Deliver result message. |

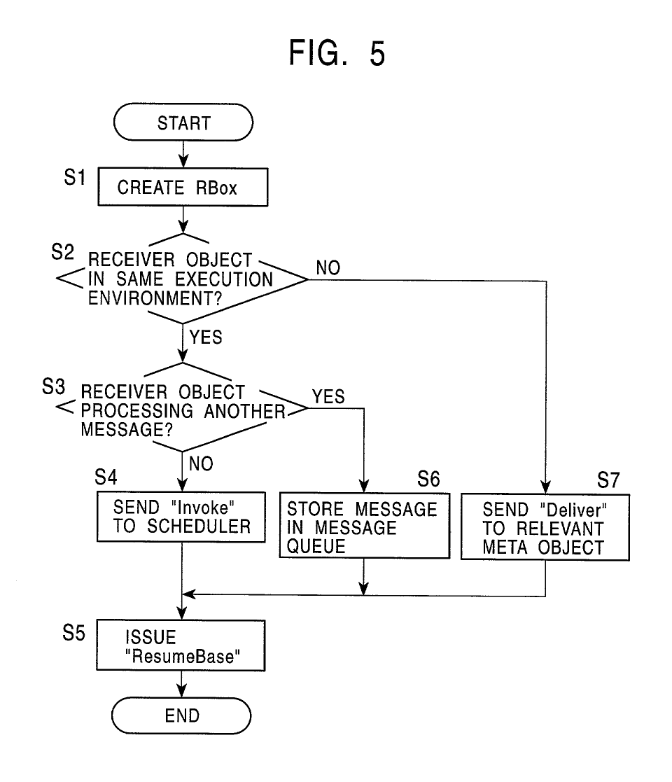

When mCOOPMailer 64 is invoked by a “SendWithRBox” message sent from a base object which is being executed in mCOOP, for example, an application program 51 in FIG. 4, mCOOPMailer 64 executes the method shown in the flowchart of FIG. 5.

First, in step S1, mCOOPMailer 64 creates an RBox for storing a result message, and returns to the sender object an identifier RID which identifies the RBox.

Next, in step S2, mCOOPMailer 64 determines whether the receiver object exists in the same execution environment as the sender object.

If the receiver object is found to exist in the same execution environment, the method proceeds to Step S3, in which mCOOPMailer 64 further determines whether the receiver object is processing another message.

If it is further found that the receiver object is not processing another message, the method proceeds to step S4, in which mCOOPMailer 64 sends an “Invoke” message to the scheduler 66 to invoke the receiver object with the message.

If it is found that the receiver object is processing another message, the method proceeds to step S6, in which mCOOPMailer 64 stores the message in the message queue.

If the receiver object is found to exist in a different execution environment, the method proceeds to Step S7, in which mCOOPMailer 64 sends a “Deliver” message to a meta object which implements message communication in that execution environment. At this time, the message specified by the base object in the SendWithRBox message, and TID, a tag identifier TID which identifies an execution environment, converted from RID, are transmitted together with the “Deliver” message.

Finally, in step S5, mCOOPMailer 64 issues a “ResumeBase” message to resume execution of the base object.

When mCOOPMailer 64 is invoked by a “Receive” message sent from a base object in mCOOP, mCOOPMailer 64 searches for the RBox corresponding to the RID specified in the argument thereof.

If a result message has already been stored in the RBox, mCOOPMailer 64 returns the result message to the base object, and issues a “ResumeBase” message to resume execution of the base object. If the result message has not yet been stored in the RBox, mCOOPMailer 64 specifies an area for receiving the result message as RBox, and then issues an “ExitFromMetaCall” message to exit execution while leaving execution of the base object suspended.

When mCOOPMailer 64 is invoked by a “Reply” message sent from a base object in mCOOP, mCOOPMailer 64 converts into a TID an RID corresponding to the execution thread which issued the “Reply” message, and then determines whether the TID is an identifier for the same execution environment.

If the TID is for the same execution environment, mCOOPMailer 64 searches the RBox by the RID. If a “Receive” message has already been issued to the RBox, a result message specified in an argument of the “Reply” message is stored in an area specified by the base object which issued the “Receive” message. Then, mCOOPMailer 64 issues a “Resume” message to the scheduler 66 to resume execution of the base object which issued the “Receive” message. If any “Receive” message has not yet been issued to the RBox, the result message specified in an argument of the “Reply” message is stored in the RBox.

If the TID is for a different execution environment, mCOOPMailer 64 identifies by the TID the meta object which implements message communication under the execution environment to which the result message is delivered, and sends a “DeliverTag” message thereto. At this time, the result message and the TID are specified. Finally, a mCOOPMailer 64 issues a “ResumeBase” message to resume execution of the application program.

When mCOOPMailer 64 is invoked by an “Exit” message sent from a base object in mCOOP, mCOOPMailer 64 checks the message queue of the base object.

If any message is stored in the message queue, mCOOPMailer 64 sends an “Invoke” message to the scheduler 66 to invoke the receiver object with the message.

If no message is stored in the message queue, mCOOPMailer 64 sends a “Terminate” message to the scheduler 66 to terminate execution of the base object.

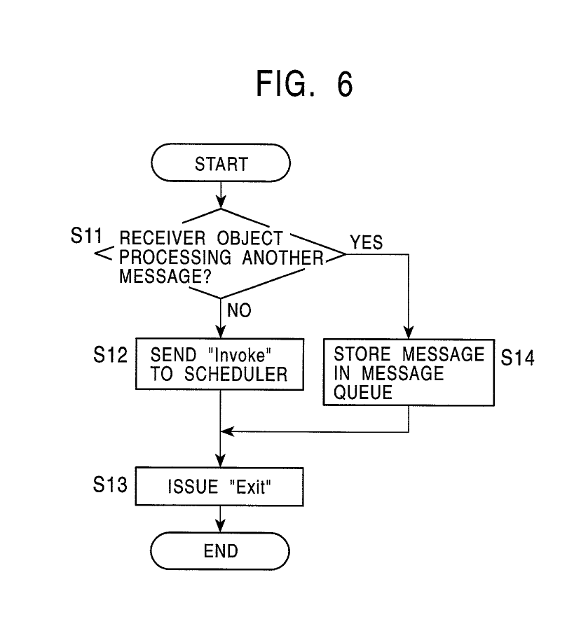

When mCOOPMailer 64 is invoked by a “Deliver” message sent from a meta object, mCOOPMailer 64 executes the method shown in the flowchart of FIG. 6.

mCOOPMailer 64 delivers a message to a receiver object as specified in the argument of a “Deliver” message.

In step S11, mCOOPMailer 64 determines whether the receiver object is processing another message.

If it is found that the receiver object is not processing another message, the method proceeds to Step 12, in which mCOOPMailer 64 sends an “Invoke” message to the scheduler 66 to invoke the receiver object with the message.

If the receiver object is processing another message, the method proceeds to step S14, in which mCOOPMailer 64 stores the message in the message queue.

Finally, in step S13, mCOOPMailer 64 issues an “Exit” message to exit execution.

When mCOOPMailer 64 is invoked by a “DeliverTag” message sent from a meta object, mCOOPMailer 64 converts into an RID a TID specified in the argument of the “DeliverTag” message, and searches for the RBox corresponding to the RID.

If a “Receive” message has already been issued to the RBox, a result message specified in an argument of a “Reply” message is stored in an area specified by a base object which issued the “Receive” message. mCOOPMailer 64 then sends a “Resume” message to the scheduler 66 to resume execution of the base object which issued the “Receive” message.

If no “Receive” message has been issued to the RBox, mCOOPMailer 64 stores in the RBox the result message specified by the “DeliverTag” message. Then, mCOOPMailer 64 issues an “Exit” message to exit execution.

mDriveMailer 65 shown in FIG. 4 is an object which provides message communication services to the device driver execution environment mDrive. Similarly to mCOOPMailer 64, mDriveMailer 65 is one of the objects constituting the operating system 53, and is implemented as a component object of the complex object UnifiedMailer 57.

mDriveMailer 65 receives the messages listed in Table 2 given below and executes the corresponding operations.

TABLE 2

| Message | Action |
|---|---|
| SendWithContinuation | 1. Create Continuation and returns ContID. |
| | 2. If the receiver object is under the same |
| | execution environment, deliver message to the |
| | receiver object. |
| | 3. If the receiver object is under a different |
| | execution environment, send “Deliver” message |
| | to the meta object which executes message |
| | communication under that execution environment. |
| Kick | 1. Convert ContID into TID. |
| | 2. If the TID is for the same execution |
| | environment, deliver result message and |
| | continuation message to the continuation object |
| | specified in Continuation. |
| | 3. If the TID is for a different execution |
| | environment, send a “DeliverTag” message. |
| Exit | 1. Send messages in the message queue, if any. |
| | 2. Otherwise, exit execution. |
| Deliver | Deliver message. |
| DeliverTag | Deliver result message. |

When mDriveMailer 65 is invoked by a “SendWithContinuation” message sent from a base object in mDrive, for example, the device driver 52, mDriveMailer 65 creates a “Continuation” which stores continuation information within the base object. mDriveMailer 65 then returns an identifier ContID which identifies the “Continuation” to the base object which sent the “SendWithContinuation” message. mDriveMailer 65 also determines whether the receiver object is in the same execution environment as the sender object.

If the receiver object is found to exist in the same execution environment, mDriveMailer 65 further determines whether the receiver object is processing another message. If it is determined that the receiver object is not processing another message, mDriveMailer 65 sends an “Invoke” message to the scheduler 66 to invoke the receiver object with the message and the ContID. If it is determined that the receiver object is processing another message, mDriveMailer 65 stores the message in the message queue.

If the receiver object is found to exist in a different execution environment, mDriveMailer 65 sends a “Deliver” message to a meta object which implements message communication in that execution environment. At this time, the message specified by the base object in the “SendWithContinuation” message and a TID converted from the ContID are transmitted together with the “Deliver” message.

Finally, mDriveMailer 65 issues a “ResumeBase” message to resume execution of the base object.

When mDriveMailer 65 is invoked by a “Kick” message sent from a base object in mDrive, mDriveMailer 65 converts into an TID a ContID specified in an argument of the “Kick” message, and then determines whether the TID is an identifier in the same execution environment.

If the TID is for the same execution environment, mDriveMailer 65 searches for “Continuation” by the ContID. mDriveMailer 65 then sends an “Invoke” message to the scheduler 66 to invoke the continuation object with the continuation message specified in the “Continuation” and a result message.

If the TID is for a different execution environment, mCOOPMailer 64 identifies by the TID the meta object which implements message communication under the execution environment to which the the result message is delivered, and sends a “DeliverTag” message thereto. At this time, the result message and the TID are specified. Finally, mDriveMailer 65 issues a “ResumeBase” message to resume execution of the base object.

When mDriveMailer 65 is invoked by an “Exit” message sent from a base object in mDrive, mDriveMailer 65 checks the message queue of the base object.

If any message is stored in the message queue, mDriveMailer 65 sends an “Invoke” message to the scheduler 66 to invoke the receiver object together with the message. If no message is stored in the message queue, mDriveMailer 65 sends a “Terminate” message to the scheduler 66 to terminate execution of the base object.

When mDriveMailer 65 is invoked by a “Deliver” message sent from a meta object, mDriveMailer 65 executes the method shown in the flowchart of FIG. 6.

mDriveMailer 65 delivers a message to a receiver object as specified in the argument thereof.

In step S11, mDriveMailer 65 determines whether the receiver object is processing another message.

If it is determined that the receiver object is not processing another object, the method proceeds to step S12, in which mDriveMailer 65 sends an “Invoke” message to the scheduler 66 to invoke the receiver object with the message.

If the receiver object is processing another object, the method proceeds to step S14, in which mDriveMailer 65 stores the message in the message queue.

Finally, in step S13, mDriveMailer 65 issues an “Exit” message to exit execution.

When mDriveMailer 65 is invoked by a “DeliverTag” message sent from a meta object, mDriveMailer 65 converts into a ContID a TID specified in an argument of the “DeliverTag” message, and searches for “Continuation” corresponding to the ContID. Then, mDriveMailer 65 sends an “Invoke” message to the scheduler 66 to invoke the continuation object with the continuation message specified in Continuation and the result message.

The scheduler 66 shown in FIG. 4 is an object which provides services related to scheduling of execution thread of objects. Similarly to mCOOPMailer 64 and mDriveMailer 65, the scheduler 66 is one of the objects constituting the operating system 53.

The scheduler 66 receives the messages listed below and executes the corresponding operations.

TABLE 3

| Message | Action |
|---|---|
| Invoke | Invoke execution thread. |
| Resume | Resume execution of execution |
| | thread. |
| Terminate | Terminate execution of the |
| | execution thread. |
| ResumeBase | Terminate execution of meta |
| | object and resumes execution |
| | of base object. |
| ExitFromMetaCall | Terminate execution of meta |
| | object while leaving |
| | execution of base object |
| | suspended. |

When the scheduler 66 is invoked by an “Invoke” message sent from a meta object, the scheduler 66 schedules an execution thread, specified in the argument of the “Invoke” message, according to a particular scheduling policy, and invokes the execution thread accordingly.

When the scheduler 66 is invoked by a “Resume” message sent from a meta object, the scheduler 66 schedules execution of a suspended execution thread specified in the argument of the “Resume” message, and resumes execution of the execution thread accordingly.

When the scheduler 66 is invoked by a “Terminate” message sent from a meta object, the scheduler 66 terminates execution of an execution thread specified in the argument of the “Terminate” message.

When the scheduler 66 is invoked by a “ResumeBase” message sent from a meta object, the scheduler 66 terminates execution of the meta object and resumes execution of the base object which issued the meta call.

When the scheduler 66 is invoked by an “ExitFromMetaCall” message sent from a meta object, the scheduler 66 terminates execution of the meta object while leaving suspended execution of the base object which issued the meta call.

UnifiedMailer 57 is a complex object constituting the operating system 53, and includes the above-described mCOOPMailer 64 and mDriveMailer 65 as component objects thereof.

UnifiedMailer 57 provides “UnifiedMailermCore”, an API compatible with the system environment mCore, for the component objects included therein. Thus, each of the component objects mCOOPMailer 64 and mDriveMailer 65 permits programming in the same manner as for ordinary meta objects.

UnifiedMailer 57, in order to implement “UnifiedMailermCore” API, includes a call history 8 which stores information relating to history of message communication of the component objects.

In this embodiment, the call history 8 is set to “External”, which indicates execution in a different execution thread, when one of the component objects within UnifiedMailer 57 is invoked by a message or a meta-call from an object external to UnifiedMailer 57.

The below describes messages of “UnifiedMailermCore” API the complex object UnifiedMailer 57 provides for the component objects thereof.

Send:

“Send” message is used to send a message from a sender meta object to a receiver meta object to thereby invoke a method as specified in the argument thereof.

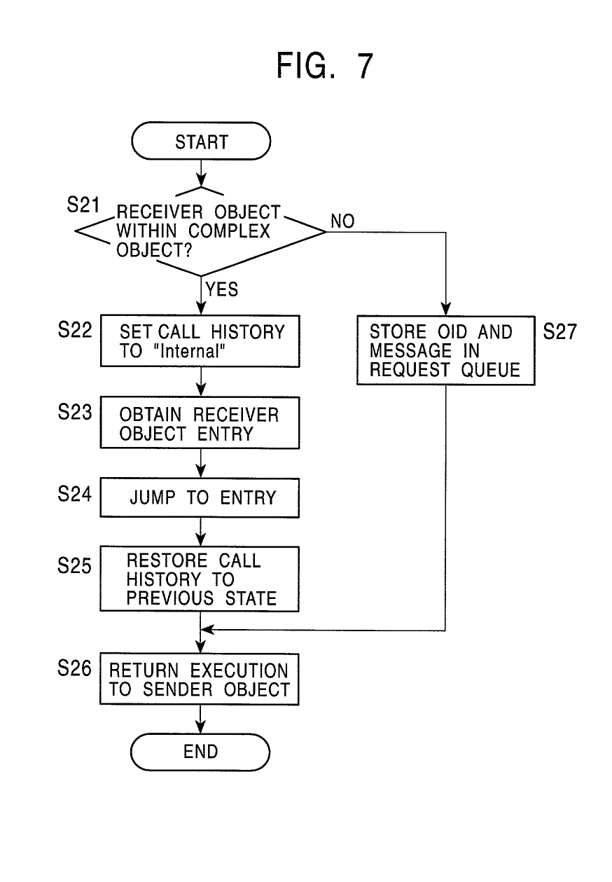

FIG. 7 shows a method invoked by a “Send” message.

First, step S21 determines whether the receiver object is one of the component objects within UnifiedMailer 57.

If the receiver object is found to be one of the component objects within UnifiedMailer 57, the method proceeds to step S22, setting the call history 8 in UnifiedMailer 57, which stores information relating to history of message communication, to “Internal” which indicates an execution within the same execution thread.

Next, step 23 obtains an entry for the receiver object from the execution thread. Then, in step 24, the method jumps to the entry to start execution of the receiver object. At this time, the execution thread is not switched, i.e., processing is performed in the same execution thread, which is equivalent to a function call in that regard.

When the method returns from execution of the receiver object, in step S25, the call history 8 is restored to the previous state in which the “Send” message is issued, and in step S26, execution of the sender object is resumed from the point at which the “Send” message is issued.

When the receiver object is found to be an object external to UnifiedMailer 57, in step S27, UnifiedMailer 57 stores the message and information regarding the receiver object in the request queue 9 therein.

Exit:

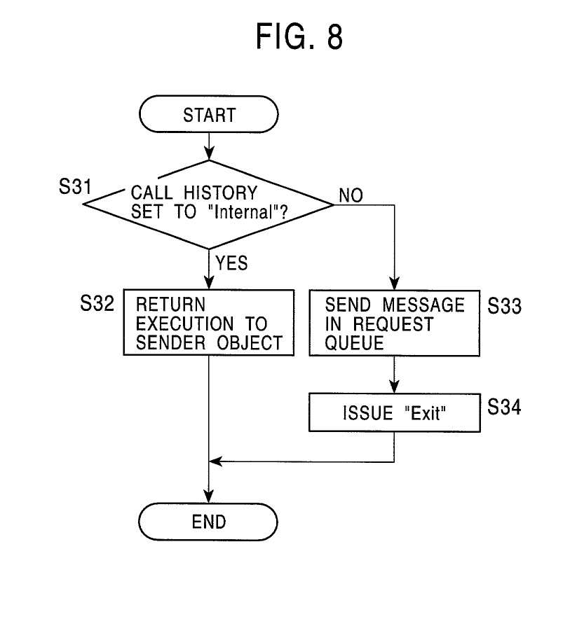

“Exit” message is used to terminate execution of the meta object invoked by a “Send” message. FIG. 8 shows a flowchart of a method invoked by an “Exit” message.

UnifiedMailer 57 first checks in step S31 the state of the call history 8, which stores information relating to history of message communication.

If the call history 8 is set to “Internal”, which indicates execution within the same thread, a processing equivalent to a return-from-function processing is performed in step S32, passing the control to the caller component object.

If the call history 8 is set to “External”, which indicates execution in a different execution thread, in step S33, UnifiedMailer 57 wraps up the message or messages stored in the request queue 9 for each of the receiver objects, and sends the message or messages using a “Send” API message of mCore. Then, in step S34, UnifiedMailer 57 issues an “Exit” API message of mCore to terminate execution of the meta object.

ResumeBase:

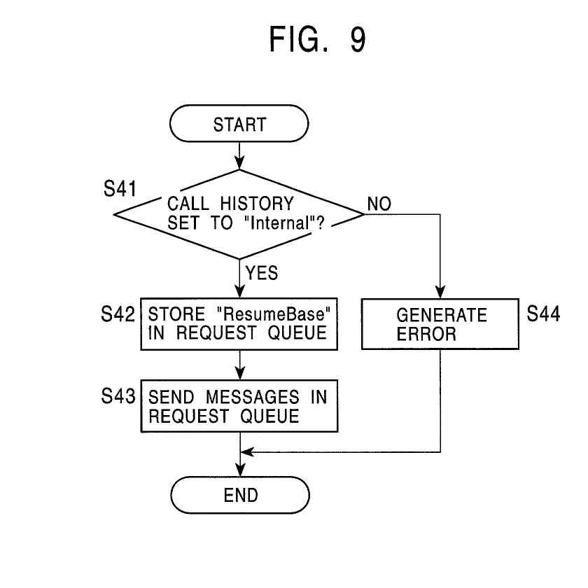

“ResumeBase” is used to terminate execution of the meta object invoked by a meta-call while resuming execution of the base object which issued the meta-call. FIG. 9 shows a flowchart of a method invoked by a “ResumeBase” message.

UnifiedMailer 57 first checks in step S41 the state of the call history 8 which stores information relating to history of message communication.

If the call history 8 is set to “Internal” which indicates an execution within the same execution thread, the method proceeds to step S42, specifying the scheduler 66 as the receiving object and storing the “ResumeBase” message in the request queue 9 of UnifiedMailer 57. Then, in step S43, UnifiedMailer 57 wrap up the messages stored in the request queue 9 for each of the receiver objects, and send the messages using “Send” message of mCore. When the scheduler 66 receives the “ResumeBase” message, the meta-call is exited to terminate execution of the meta object and to simultaneously resume execution of the base object.

If the call history 8 is set to “External”, which indicates an execution in a different thread, the method proceeds to step S44, generating an error.

ExitFromMetaCall

“ExitFromMetaCall” API message is used to terminate execution of a meta object invoked by a meta call, similarly to the procedure shown in FIG. 9; however, execution of the base object is kept suspended.

UnifiedMailer 57 first checks in step S41 the state of the call history 8 which stores information relating to history of message communication.

If the call history 8 is set to “Internal” which indicates execution within the same execution thread, the method proceeds to step S42, specifying the scheduler 66 as the receiver object and storing the “ExitFromMetaCall” message, instead of the “ResumeBase” message, in the request queue 9 of UnifiedMailer 57. Then, in step S43, UnifiedMailer 57 wraps up the messages stored in the request queue 9 for each of the receiver objects, and send the messages using “Send” message of mCore. When the scheduler 66 receives the “ExitFromMetaCall” message, the meta-call is exited to terminate execution of the meta object while leaving suspended execution of the base object at the point where the meta-call is issued.

If the call history 8 is set to “External”, which indicates an execution in a different thread, the method proceeds to step S44, generating an error.

Next, described below is a scenario in which message communication occurs between different execution environments provided by the object-oriented operating system in this embodiment.

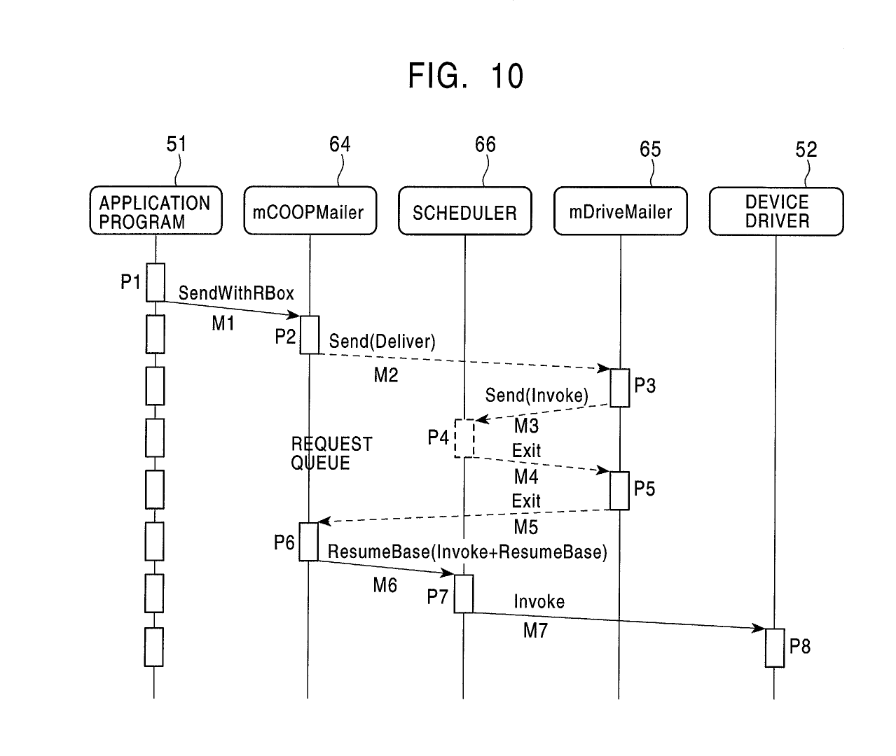

FIG. 10 shows a procedure of processing among the objects when message communication from an application program operating on the execution environment mCOOP to a device driver operating on the execution environment mDrive is performed using “SendWithRBox” API message provided by mCOOP. For simplicity, processing for returning messages is omitted.

The application program issues in processing P1 a “SendWithRBox” message provided by mCOOP. At this time, the “SendWithRBox” API message issues a meta-call so that a migration is made from the execution thread of the base object to the execution thread of the meta object. Because the meta-call is from outside the complex object UnifiedMailer 57, the call history 8, which stores information relating to history of message communication, is set to “External”, which indicates an execution in an external execution thread.

When mCOOPMailer 64 receives the “SendWithRBox” message, in the subsequent processing P2, mCOOPMailer 64 executes the method shown in FIG. 5. mCOOPMailer 64 first creates in step S1 an RBox for storing a result message. Then, an identifier RID for identifying the RBox is set in an RID storing area of the sending object, so that the application program is allowed to obtain the RID when “SendWithRBox” message is exited. The RID storing area is specified by the application program in the argument of the “SendWithRBox” message.

Next, step S2 determines whether the receiver object is under the same execution environment. This is done by searching the object description information which can be obtained from the object table 70 using the OID.

In the scenario shown in FIG. 10, the receiver object, i.e., the device driver, is under the execution environment mDrive. Accordingly, step S2 determines that the receiver object is under an execution environment different from the execution environment mCOOP of the sending object. In this case, the method proceeds to step S7.

In step S7, mCOOPMailer 64 sends a “Deliver” message using a “Send” API message of UnifiedMailermCore to the meta object which implements message communication under the execution environment of the receiver object.

In the scenario shown in FIG. 10, the “Send” message is issued to mDriveMailer 65. The “Deliver” message is added with a message specified in the argument of the “SendWithRBox” message and a TID converted from an RID.

“Send” message of UnifiedMailermCore provided by the complex object UnifiedMailer 57 executes the method shown in FIG. 7.

First, in step S21, it is determined whether the receiver object is one of the component objects of the complex object UnifiedMailer 57. This is done by using object description information obtained by searching the object table 70 using the OID.

In the scenario shown in FIG. 10, the receiver object mDriveMailer 65 is one of the constituent objects of UnifiedMailer 57; thus, the method proceeds to step S22.

In step S22, the call history 8, which stores information relating to history of message communication, is set to “Internal”, which indicates an execution in the same execution thread.

Next, step S23 obtains an entry of the receiver object from the execution thread. Then, in step S24, the method jumps to the entry to start execution. In FIG. 10, this migration is indicated by a dotted M2. The dotted line indicates that execution thread does not actually switch.

When mDriveMailer 65 receives the “Deliver” message, the processing P3 in FIG. 10 performs the method shown in FIG. 6.

In step S11, it is determined whether the receiver object is under processing of another object. This can be done by checking whether the message queue is empty. If the receiver object is not under processing of another object, mDriveMailer 65 proceeds to step S12, and sends an “Invoke” message to the scheduler 66 using a “Send” API message of UnifiedMailermCore.

“Send” API message provided by UnifiedMailermCore executes the method shown in FIG. 7.

First, in step S21, it is determined whether the receiver object is one of the component objects of the complex object UnifiedMailer 57.

In the scenario shown in FIG. 10, the receiver object, i.e., a scheduler 66, is an ordinary object external to the complex object UnifiedMailer 57; thus, the method proceeds to step S27.

In step S27, the OID identifying the receiver object and the message are stored in the request queue 9 of UnifiedMailer 57.

The migrations M3 and M4 are respectively indicated by a dotted arrow, suggesting that execution thread does not actually switch. That is, at this time, a message is sent to the scheduler 66 from the perspective of the component objects of the complex object UnifiedMailer 57; however, the message communication is actually delayed transparently. Thus, the processing P4 of FIG. 10 has not been performed yet at this time.

When mDriveMailer 65 returns from the “Send” message of UnifiedMailermCore in the processing P3 in FIG. 10, mDriveMailer 65 in processing P5 performs the remaining of the Deliver message. More specifically, in step S13 in FIG. 6, mDriveMailer 65 issues an “Exit” API message of UnifiedMailermCore.

“Exit” API message provided by UnifiedMailermCore executes the method shown in FIG. 8.

UnifiedMailer 57 first checks in step S31 the state of the call history 8 which stores information relating to history of message communication.

In the scenario shown in FIG. 10, when “Send” API message of UnifiedMailermCore is issued from mCOOPMailer 64 to mDriveMailer 65, the call history 8 is set to “Internal” in step S22 in FIG. 7. Accordingly, “Exit” API message of UnifiedMailermCore proceeds to step S32 in FIG. 8.

In step S32, execution returns to the object which issued the “Send” API message of UnifiedMailermCore. This is done in a manner similar to a return from function. When execution returns, mCOOPMailer 64 performs the remaining portion of the “Send” API message of UnifiedMailermCore in the processing P2 in FIG. 10.

Migration M5 in FIG. 10 is indicated by a dotted arrow, suggesting that execution thread does not actually switch.

Then, execution proceeds to step S25 in FIG. 7. In step S25, the call history 8 is restored to its previous state. In the scenario shown in FIG. 10, the call history 8 is restored from “Internal” which was set when “Send” API message of UnifiedMailermCore is issued from mCOOPMailer 64 to mDriveMailer 65 (see step S22 in FIG. 7), to “External” which was set when the application program issued “SendWithRBox” API message of mCOOP to switch execution thread to UnifiedMailer 57. Thus, in step S5 in FIG. 5, “ResumeBase” API message is issued.

“ResumeBase” API message of UnifiedMailermCore provided by mCOOPMailer 64 executes the method shown in FIG. 9.

UnifiedMailer 57 first checks in step S41 the state of the call history 8 which stores information relating to history of message communication.

In the scenario shown in FIG. 10, the call history 8 is restored to “External”, which is the state when the application program issued “SendWithRBox” API message of mCOOP, i.e., when execution thread switched to UnifiedMailer 57 as a meta-call. Accordingly, “ResumeBase” API message of UnifiedMailermCore proceeds to step S42.

In step S42, the OID of the scheduler 66 and the “ResumeBase” message to the scheduler 66 are stored in the request queue 9 of UnifiedMailer 57. Then, in step S43, the messages stored in the request queue of UnifiedMailer 57 are wrapped up on a receiver object basis and are sent using “Send” API message of mCore.

In the scenario shown in FIG. 10, the “Invoke” message to the scheduler 66 which has been delayed in the migration M3 and the “ResumeBase” message to the scheduler 66 which was stored in step S42 in FIG. 9 are wrapped up to be sent to the scheduler 66 in one go using “Send” API message of mCore.

When the scheduler 66 receives the two messages “Invoke” and “ResumeBase”, in processing P7 in FIG. 10, the scheduler 66 performs processing for Invoke which has not been performed in processing P4, and processing for the new “ResumeBase”.

The scheduler 66 performs scheduling after processing for Invoke, and invokes execution thread for the device driver which receives message in migration M7. Accordingly, the device driver operating on the execution environment mDrive receives the message sent in “SendWithRBox” API message of mCOOP from the application program operating on the execution environment mCOOP, and then performs processing of the message in processing P8.

The scheduler 66 also performs processing for “ResumeBase”, exiting execution of the meta object within UnifiedMailer 57 and, although not shown in FIG. 10, resuming execution of the application program at an appropriate timing according to the scheduling result. Accordingly, the application program returns from the meta-call call of “SendWithRBox” message provided by mCOOP, continuing the subsequent processing.

In summary, in a message communication method in which a plurality of objects which cause frequent message communication thereamong are wrapped up into a single complex object, the request queue 9 which temporarily stores messages directed outside the complex object and the call history 8 which stores information relating to history of message communication among the component objects are further provided. When the component objects mCOOPMailer 64 or mDriveMailer 65 performs a message communication with the scheduler 66, the message is temporarily stored and delayed in the message queue with an OID identifying the scheduler 66 as the receiver object. Then, when execution of the component object completes, the state of the call history 8 is checked. When the call history 8 is set to “External” which indicates execution of an external execution thread, a plurality of messages stored in the request queue 9 are wrapped up for each receiver object and are delivered in a single message communication. That is, while each of the component objects mCOOPMailer 64 and mDriveMailer 65 is performing message communication, message communication directed to external objects is delayed. When operation of the complex object UnifiedMailer 57 completes, a plurality of messages is sent at a time, thereby reducing the number of message communication operation between meta objects and enhancing performance of message communication services between different execution environments mCOOP and mDrive.

In accordance with the present invention, when message communication occurs between the component objects mCOOPMailer 64 and mDriveMailer 65 of the complex object UnifiedMailer 57, cost of message communication is reduced even though message communication occurs with the scheduler 66 which is external to the complex object. In the scenario shown in FIG. 10, the migrations M3 and M4, interposed between the migrations M2 and M5, can be eliminated transparently to the constituent objects within the complex object. Thus, the method can be implemented by just adding the request queue 9 and the call history 8 to the complex object UnifiedMailer 57 as component objects thereof, without altering programming of ordinary objects.

In accordance with the present invention, a method in which a plurality of objects which cause frequent message communication thereamong is wrapped up in a single complex object reduces cost of message communication. In particular, even if messages are generated by different component objects of the complex object, the messages can be delayed and then sent in a single message communication operation.

While the present invention has been described with reference to a specific embodiment, it is to be understood by those skilled in the art that various modifications and alternative arrangements can be made without departing from the gist of the present invention. The described embodiment is for illustration only and is not intended to limit the scope of the present invention as defined solely by the appended claims.

What is claimed is:

1. A data communication method for exchanging messages, under a system environment constituted of a plurality of objects which executes message communication, between a complex object constituted of a plurality of objects having execution seriality and an independent object external to said complex object, said data communication method comprising the steps of:
(a) temporarily storing one or more messages directed from an object within said complex object to said independent object external to said complex object; and
(b) sending the one or more stored messages to said independent object in a single operation when said complex object and said independent object enter a predetermined relationship.

2. A data communication method according to claim 1, wherein said complex object is constituted of a plurality of objects which can be invoked in a manner equivalent to a function call which does not cause context switch.

3. A data communication method according to claim 1, further comprising the step of (c) creating a history of message communication by the object within said complex object,
wherein said step (b) determines whether said complex object and said independent object have entered said predetermined relationship based on said history of message communication.

4. A data communication method according to claim 1, further comprising the step of (c) creating a history of message communication by the object within said complex object,
wherein said step (b) sends the one or more stored messages in a single operation if said history of message communication is indicative of a message communication from a different execution thread when the object within said complex object exits execution.

5. A data communication method according to claim 1, wherein said step (a) controls message storing in accordance with a relationship between said complex object and said independent object.

6. A data communication method according to claim 1, wherein said step (a) controls message storing in accordance with the status of said independent object.

7. A data communication method according to claim 1, wherein said step (a) controls message storing on a destination-by-destination basis if the one or more stored messages are directed from the object within said complex object to a plurality of independent objects external to said complex object.

8. A data communication method according to claim 1, further comprising the step of (d) determining whether to store or immediately send the one or more messages in accordance with a relationship between said complex object which sends the one or more messages and said independent object which receives the one or more messages, with respect to scheduling priority level and interrupt priority level of the respective execution threads thereof.

9. A data communication method according to claim 1, wherein said system constituted of a plurality of objects is an object-oriented operating system constituted of a plurality of concurrent objects.

10. A data communication method according to claim 1, wherein said system constituted of a plurality of objects is an application program or a device driver constituted of a plurality of concurrent objects.

11. A data communication apparatus for exchanging messages, under a system environment constituted of a plurality of objects which executes message communication, between a complex object constituted of a plurality of objects having execution seriality and an independent object external to said complex object, said data communication apparatus comprising:
(a) means for temporarily storing one or more messages directed from an object within said complex object to said independent object external to said complex object; and
(b) means for sending the one or more stored messages to said independent object in a single operation when said complex object and said independent object enter a predetermined relationship.

12. A data communication apparatus according to claim 11, wherein said complex object is constituted of a plurality of objects which can be invoked in a manner equivalent to a function call which does not cause context switch.

13. A data communication apparatus according to claim 11, further comprising (c) means for creating a history of message communication by the object within said complex object,
wherein said means (b) determines whether said complex object and said independent object have entered said predetermined relationship based on said history of message communication.

14. A data communication apparatus according to claim 11, further comprising (c) means for creating a history of message communication by the object within said complex object,
wherein said means (b) sends the one or more stored messages in a single operation if said history of message communication is indicative of a message communication from a different execution thread when the object within said complex object exits execution.

15. A data communication apparatus according to claim 11, wherein said means (a) controls message storing in accordance with a relationship between said complex object and said independent object.

16. A data communication apparatus according to claim 11, wherein said means (a) controls message storing in accordance with the status of said independent object.

17. A data communication apparatus according to claim 11, wherein said means (a) controls message storing on a destination-by-destination basis if the one or more stored messages are directed from the object within said complex object to a plurality of independent objects external to said complex object.

18. A data communication apparatus according to claim 11, further comprising (d) means for determining whether to store or immediately send the one or more stored messages in accordance with a relationship between said complex object which sends the one or more messages and said independent object which receives the one or more stored messages, with respect to scheduling priority level and interrupt priority level of the respective execution threads thereof.

19. A data communication apparatus according to claim 11, wherein said system constituted of a plurality of objects is an object-oriented operating system constituted of a plurality of concurrent objects.

20. A data communication apparatus according to claim 11, wherein said system constituted of a plurality of objects is an application program or a device driver constituted of a plurality of concurrent objects.

21. A computer-readable storage medium storing a computer program for exchanging messages, under a system environment constituted of a plurality of objects which executes message communication, between a complex object constituted of a plurality of objects having an execution seriality and an independent object external to said complex object, said computer program comprising the steps of:
(a) temporarily storing one or more messages directed from an object within said complex object to said independent object external to said complex object; and
(b) sending the one or more stored messages to said independent object in a single operation when said complex object and said independent object enter a predetermined relationship.
